(19) United States
(12) Patent Application Publication
(10) Pub. No.: US 2013/0041057 A1
(43) Pub. Date: Feb. 14, 2013

(54) FORMULATION CONTAINING TIN AND/OR ZINC SALTS OF RICINOLEIC ACID, UREA, POLYETHYLENE GLYCOL AND SUGAR ALCOHOL AND USE OF THE FORMULATION IN THE PRODUCTION OF POLYURETHANE SYSTEMS

(71) Applicants: Eva Emmrich-Smolczyk, Essen (DE); Harald Modro, Gladbeck (DE)

(72) Inventors: Eva Emmrich-Smolczyk, Essen (DE); Harald Modro, Gladbeck (DE)

(73) Assignee: EVONIK GOLDSCHMIDT GMBH, Essen (DE)

(21) Appl. No.: 13/584,337

(22) Filed: Aug. 13, 2012

(30) Foreign Application Priority Data
Aug. 11, 2011 (DE) DE102011110020.6

(51) Int. Cl. C08G 18/32; C08J 9/00; C09D 175/04; C09J 175/04; C08G 18/24; C08G 18/22

(52) U.S. Cl. 521/117; 528/58; 528/55; 524/591

(57) ABSTRACT

A formulation for the production of a polyurethane system, in particular a polyurethane foam, containing or consisting of tin and/or zinc ricinoleate(s), optionally tin carboxylate(s), a mixture containing or consisting of urea, sugar alcohol and polyethylene glycol, optionally organic solvent, one or more organic isocyanates having two or more isocyanate functions, one or more polyols having two or more groups which are reactive towards isocyanate, optionally further catalysts for the isocyanate-polyol and/or isocyanate-water reactions and/or isocyanate trimerization, water, optionally physical blowing agents, optionally flame retardants and optionally further additives, a process for the production of polyurethane systems, these polyurethane systems and their use.

### FIELD OF THE INVENTION

The present invention relates to a formulation for the production of a polyurethane system, in particular a polyurethane foam, containing or consisting of tin and/or zinc ricinoleate(s), a mixture containing or consisting of urea, sugar alcohol and polyethylene glycol, one or more organic isocyanates having two or more isocyanate functions, one or more polyols having two or more groups which are reactive towards isocyanate, and water, a process for the production of polyurethane systems, these polyurethane systems and their use.

### BACKGROUND OF THE INVENTION

Polyurethane systems are, for example, polyurethane coatings, polyurethane adhesives, polyurethane sealants, polyurethane elastomers or polyurethane foams.

Polyurethane foams are used in a variety of fields because of their excellent mechanical and physical properties. A particularly important market for a variety of types of PUR foams such as conventional flexible foams based on ether polyols and ester polyols, cold-cure foams (frequently also referred to as HR foams), rigid foams, integral foams and microcellular foams and also foams whose properties lie between these classifications, e.g., semirigid systems, is the automobile industry and the furniture industry. For example, rigid foams are used as roof interior, ester foams are used for the interior lining of doors and for stamped-out sun visors, cold-cure and flexible foams for seat systems and mattresses.

Catalysts suitable for one-component moisture-reactive polyurethane compositions usually contain tin compounds such as tin carboxylates, in particular tin octoate (corresponds to tin 2-ethylhexanoate), frequently combined with tertiary amines

Thus, the use of tin octoate in the production of flexible PUR foams based on polyetherols is described, for example, in Steve Lee, Huntsman Polyurethanes, The Polyurethanes Book, Wiley, pp. 140, 143-144. The tin octoate serves as catalyst for the reaction of isocyanates with polyols (also referred to as gel catalyst) via a complex transition state. During the production of the foam, the tin octoate hydrolyses and liberates both the salt of 2-ethylhexanoic acid and also the acid itself. Although the decomposition is desirable because the backreaction of the urethane bond to the starting materials is suppressed in this way, it should if possible not lead to liberation of any substances which are of toxicological concern. The patent literature also contains numerous applications which describe the use of said tin octoate, e.g., GB 1432281, GB 1422056, GB 1382538, GB 1012653 or GB 982280. In these documents, catalyst systems comprising tin octoate are used as preferred catalyst systems.

Dibutyltin dilaurate (DBTDL) is one of the most efficient catalysts in the production of polyurethane foams, in particular high resilience (HR) polyurethane foams, in particular by the slabstock method, because in this case it is important to make the density distribution over a large foam block as homogeneous as possible. For health and ecotoxicological reasons, the use of DBTDL is increasingly avoided in the production of polyurethane foams.

To meet the demands made of the automobile and furniture industry and their foam suppliers in respect of emissions and toxicity specifications, which have become significantly more stringent in recent years, catalyst systems which contain less toxic ligands polymerized into the foam have already been developed. Such systems based on, for example, ricinoleic acid are described, for example, in EP 1013704.

The above-mentioned systems have to date been one of the few alternatives to the widespread tin octoate catalyst system (tin(II) salt of 2-ethylhexanoic acid) or organotin compounds such as dibutyltin dilaurate. The latter systems in particular are critical in terms of the toxicity of the substances emitted. For example, the 2-ethylhexanoic acid liberated during and after foaming gives cause for concern because of possible risk of harm to the unborn child (harm to foetal development) in human beings (R 63).

However, the tin carboxylates which are used as alternative catalysts frequently lead to large density fluctuations in the resulting foam block, which also have effects on the dimensional stability.

Foam blocks are usually processed to produce mattresses by cutting the block into uniform slices. A homogeneous distribution of the density over the entire foam block is particularly important. Mechanical properties such as the indentation resistance are linked to the density. When slices, e.g., mattresses, are cut from a severely deformed polyurethane foam block, large quantities of scrap are obtained.

### SUMMARY OF THE INVENTION

It is therefore an object of the present invention to provide an alternative formulation for producing polyurethanes, in particular polyurethane foams, which overcomes the abovementioned disadvantages. The formulation according to the invention has only small amounts of, and preferably no, DBTDL and in the production of HR polyurethane foams makes it possible to obtain foam blocks which have a very homogeneous density distribution.

It has surprisingly been found that formulations which comprise tin ricinoleate and/or zinc ricinoleate and also a mixture containing or consisting of urea, sugar alcohol and polyethylene glycol achieve this object.

The present invention accordingly provides a formulation for the production of a polyurethane system, in particular a polyurethane foam, containing or consisting of tin and/or zinc ricinoleate(s) and optionally further tin carboxylate(s), a mixture containing or consisting of urea, sugar alcohol and polyethylene glycol, optionally organic solvent, one or more organic isocyanates having two or more isocyanate functions, one or more polyols having two or more groups which are reactive towards isocyanate, optionally further catalysts for the isocyanate-polyol and/or isocyanate-water reactions and/or isocyanate trimerization, water, optionally physical blowing agents, optionally flame retardants and optionally further additives.

The present invention likewise provides for the use of the formulations of the invention in a process for the production of polyurethane systems, preferably polyurethane coatings, polyurethane adhesives, polyurethane sealants, polyurethane elastomers or polyurethane foams and also the use of polyurethane systems according to the invention as refrigerator insulation, insulation board, sandwich element, pipe insulation, spray foam, 1- & 1.5-component pressure-pack foam, imitation wood, modelling foam, packaging foam, mattress, furniture upholstery, automobile seat upholstery, headrest, dashboard, automobile interior trim, automobile interior roof, sound absorption material, steering wheel, shoe sole, carpet backing, filter foam, sealing foam, sealant and adhesive or for producing corresponding products.

The formulations of the invention have the advantage that they can be used both for producing flexible foams based on ether polyols and ester polyols and also for producing rigid foams and also foams whose properties lie between these classifications, e.g., semirigid foams.

The formulations of the invention also have the advantage that the viscosity of the composition can be set in a targeted manner by selection of the carboxylate radicals in the tin carboxylates. In addition, properties such as tin content, molecular weight and thus also activity or reactivity of the catalyst system can be set in a targeted manner.

The formulations of the invention have the additional advantage that they can be completely free of organotin compounds, i.e., compounds having an Sn—C bond. In particular, the formulations of the invention are free of DBTDL.

Polyurethane foam blocks produced using the formulations of the invention have a relatively uniform (foam) density over the entire block. As a result of the relatively uniform foam density, polyurethane foam blocks which have only minor hardness differences within the block are obtained.

As a result of the use of the formulations of the invention in the production of polyurethane foam blocks, foam blocks which have only minor deformation are obtained, so that pieces can be cut from these blocks without a great deal of scrap being produced.

### DETAILED DESCRIPTION OF THE INVENTION

The formulations of the invention, the process and the use for producing polyurethane foams, the polyurethane foams themselves and their uses are described by way of example below, without the invention being restricted to these illustrative embodiments. Where ranges, general formulae or classes of compounds are indicated below, these should be interpreted as encompassing not only the respective ranges or groups of compounds which are explicitly mentioned but also all subranges and subgroups of compounds which can be obtained by leaving out individual values (ranges) or compounds. Where documents are cited in the present description, the contents thereof, in particular in respect of the subjects being referred to, are to be incorporated in their entirety into the disclosure content of the present invention. Where percentages are reported below, these are, unless indicated otherwise, percentages by weight. Where averages are indicated below, these are, unless indicated otherwise, the number average. Where materials properties such as viscosities or the like are indicated below, these are, unless indicated otherwise, the materials properties at 25° C.

The formulations of the invention, in particular for producing a polyurethane system, preferably a polyurethane foam, contain or consist of tin and/or zinc ricinoleate(s) and optionally further tin carboxylate(s), a mixture containing or consisting of urea, sugar alcohol and polyethylene glycol, optionally organic solvents, one or more organic isocyanates having two or more isocyanate functions, one or more polyols having two or more groups which are reactive towards isocyanate, optionally further catalysts for the isocyanate-polyol and/or isocyanate-water reactions and/or isocyanate trimerization, water, optionally physical blowing agents, optionally flame retardants and optionally further additives.

All known sugar alcohols can be used or be present as sugar alcohols. Preferably, the sugar alcohol is a monosaccharide sugar alcohol of the formula CₙH2ₙ₊₂Oₙ, where n=5 or 6, preferably xylitol, d-glucitol (sorbitol) or d-mannitol, preferably d-glucitol.

All known polyethylene glycols can be used as polyethylene glycols. Those polyethylene glycols which are present as a waxlike solid at 23° C. and atmospheric pressure are preferably used. The mixture in the formulation of the invention preferably has, as polyethylene glycol, one or more polyethylene glycols, preferably having an average molecular weight Mw of from 100 to 1500 g/mol, preferably from 250 to 1000 g/mol and particularly preferably from 500 to 750 g/mol.

The weight ratio of urea to sugar alcohol is preferably from 1:1 to 1:10, more preferably from 1:1.5 to 1:5 and particularly preferably from 1:2 to 1:4.

The weight ratio of urea to polyethylene glycol is preferably from 1:0.5 to 1:4, more preferably from 1:0.75 to 1:3 and particularly preferably from 1:1 to 1:2.

It may be advantageous if the formulation of the invention comprises, in addition to at least one tin and/or zinc ricinoleate, at least one further tin carboxylate which is not a tin ricinoleate. As tin and zinc salts, preference is given to using the tin(II) and zinc(II) salts.

The mass ratio of the sum of the masses of tin ricinoleate and zinc ricinoleate to the sum of the mass of the further tin carboxylates in the formulation of the invention is preferably from 10:1 to 1:1, more preferably from 5:1 to 1.5:1 and particularly preferably from 4:1 to 2:1.

The further tin carboxylate(s) is/are preferably selected from monocarboxylic acids having from 1 to 30, preferably from 4 to 18 and particularly preferably from 8 to 12, carbon atoms, in particular tin salts of n-octanoic acid, n-nonanoic acid, 3,5,5-trimethylhexanoic acid, n-decanoic acid or 2-ethylhexanoic acid. Preferred tin carboxylates are those derived from carboxylic acids which do not have exclusively a single ethyl or n-propyl branch in the 2 position. Particularly preferred tin carboxylates are the tin salts of 3,5,5-trimethylhexanoic acid or n-octanoic acid.

The tin or zinc ricinoleates and the further tin carboxylates present in the formulation of the invention can be obtained, for example, by reacting the corresponding acids or salts thereof, in particular alkali metal salts, with SnCl₂. This reaction can, for example, be carried out as described in U.S. Pat. No. 4,532,262.

As optional organic solvent, the formulation of the invention preferably has one or more aprotic solvents. If the formulation of the invention contains at least one organic solvent, this is preferably selected from among polyols, esters, polyesters, olefins, phthalates, end-capped polyethers or mineral oils.

The formulation of the invention can have further components such as one or more amines, in particular tertiary amines, one or more silicone stabilizers and optionally one or more emulsifiers in addition to the solvent or solvents or in place of the solvents.

Suitable isocyanates for the purposes of the present invention are preferably all polyfunctional organic isocyanates, for example diphenylmethane 4,4′-diisocyanate (MDI), tolylene diisocyanate (TDI), hexamethylene diisocyanate (HMDI) and isophorone diisocyanate (IPDI). The mixture of MDI and more highly condensed analogues having an average functionality of from 2 to 4 known as “polymeric MDI” (“crude MDI”) and the various isomers of TDI in pure form or as isomer mixture are particularly suitable. Particularly preferred isocyanates are mixtures of TDI and MDI.

Suitable polyols for the purposes of the present invention are preferably all organic substances having a plurality of groups which are reactive towards isocyanates, and also preparations thereof. Preferred polyols are all polyether polyols and polyester polyols which are customarily used for producing polyurethane systems, in particular polyurethane foams. Polyether polyols are obtained by reaction of polyhydric alcohols or amines with alkylene oxides. Polyester polyols are based on esters of polybasic carboxylic acids (which can be either aliphatic, for example adipic acid, or aromatic, for example phthalic acid or terephthalic acid) with polyhydric alcohols (usually glycols). In addition, polyethers based on natural oils (natural oil-based polyols, NOPs) can be used. These polyols are obtained from natural oils such as soybean oil or palm oil and can be used in unmodified or modified form.

A suitable ratio of isocyanate to polyol, expressed as index of the formulation, is in the range from 10 to 1000, preferably from 40 to 350. This index is the ratio of isocyanate actually used to isocyanate calculated (for a stoichiometric reaction with polyol). An index of 100 represents a molar ratio of the reactive groups of 1:1.

The amount of tin and zinc salts present in the formulation of the invention is preferably from 0.01 to 5 pphp (=parts by weight of tin and zinc ricinoleates and tin carboxylates per 100 parts by weight of polyol), preferably from 0.05 to 1 pphp.

Suitable further catalysts which can be additionally present in the formulation of the invention are substances which catalyze the gel reaction (isocyanate-polyol), the blowing reaction (isocyanate-water) or the dimerization or trimerization of the isocyanate. Typical examples are amines such as triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin compounds such as dibutyltin dilaurate and potassium salts such as potassium acetate. Preference is given to using catalysts which contain no organic tin compounds, in particular no dibutyltin dilaurate, as further catalysts.

Suitable amounts of these additional catalysts depend on the type of catalyst and are usually in the range from 0.01 to 5 pphp (=parts by weight per 100 parts by weight of polyol) or from 0.1 to 10 pphp for potassium salts.

Suitable water contents in the formulation of the invention depend on whether or not physical blowing agents are used in addition to water. In the case of purely water-blowing foams, the values are typically from 1 to 20 pphp, while if other blowing agents are additionally used, the amount used is reduced to usually 0 or from 0.1 to 5 pphp. To attain higher foam densities, neither water, nor other blowing agents are added.

Suitable physical blowing agents for the purposes of the present invention are gases, for example liquefied CO₂, and volatile liquids, for example hydrocarbons having 4 or 5 carbon atoms, preferably cyclopentane, isopentane and n-pentane, fluorinated hydrocarbons, preferably HFC 245fa, HFC 134a and HFC 365mfc, chlorofluorocarbons, preferably HCFC 141b, oxygen-containing compounds such as methyl formate and dimethoxymethane, or chlorinated hydrocarbons, preferably dichloromethane and 1,2-dichloroethane. Further suitable blowing agents are ketones (e.g., acetone) or aldehydes (e.g., methylal).

Apart from water and optionally physical blowing agents, it is also possible for other chemical blowing agents which react with isocyanates to evolve gas, for example formic acid or carbonates to be contained or present in the formulation of the invention.

Suitable flame retardants for the purposes of the present invention are preferably liquid organic phosphorus compounds such as halogen-free organic phosphates, e.g., triethyl phosphate (TEP), halogenated phosphates, e.g., tris(1-chloro-2-propyl)phosphate (TCPP) and tris(2-chloroethyl)phosphate (TCEP), and organic phosphonates, e.g., dimethyl methanephosphonate (DMMP), dimethyl propanephosphonate (DMPP), or solids such as ammonium polyphosphate (APP) and red phosphorus. Furthermore, halogenated compounds, for example halogenated polyols, and solids such as expandable graphite and melamine are suitable as flame retardants.

The formulations of the invention can be used in all processes for the production of polyurethane systems.

The process of the invention for the production of a polyurethane system is characterized in that a formulation of the invention is used or utilized. Using the process of the invention, polyurethane coatings, polyurethane adhesives, polyurethane sealants, polyurethane elastomers or polyurethane foams are preferably produced as polyurethane systems.

The processing of the formulations to give polyurethane systems, in particular polyurethane foams, can be carried out by all processes with which a person skilled in the art would be familiar, for example manual mixing processes or preferably by means of high-pressure or low-pressure foaming machines. The process of the invention can be carried out continuously or batchwise. A batch process is preferred in the production of moulded foams, refrigerators or panels. A continuous procedure is preferred in the production of insulation boards, metal composite elements, blocks or in the case of spray processes.

In the process of the invention, the constituents of the formulation of the invention are preferably mixed together directly before or even during the reaction (to form the urethane bonds). The constituents of the formulation are preferably combined/introduced in a mixing head.

In the process of the invention (use according to the invention), the direct introduction of a catalyst system which comprises exclusively tin and/or zinc ricinoleate(s) and optionally tin carboxylate(s) is preferred. In the direct introduction of the catalyst system, the mixture composed of tin and/or zinc ricinoleate(s) and optionally tin carboxylate(s) should preferably be present in liquid form in order to ensure simple addition without the use of solvents.

Both the viscosity and the metal content of the catalyst system can be varied by altering the chain length of the acid, so that a reactivity and viscosity which is optimal for the respective system can be set. Direct introduction of the viscous zinc/tin ricinoleate (salt of ricinoleic acid) into the polyurethane system components, in particular foaming components, can, on the other hand, lead to problems because of the very high viscosity thereof. Since many foaming machines have only direct introduction, a product which can be matched individually to the given conditions is therefore of great advantage.

As an alternative to direct foaming, the catalyst system can also be introduced in diluted form. Preference is in this case given to water-free solutions since some tin/zinc salts have only limited hydrolysis stability.

The polyurethane systems of the invention can be produced by means of the formulations of the invention. In the present disclosure, the term polyurethane is used as collective term for a polymer produced from diisocyanates or polyisocyanates and polyols or other species which are reactive toward isocyanate, e.g., amines, with the urethane bonding not having to be the exclusive or predominant bonding type. Polyisocyanurates and polyureas are expressly also included.

The polyurethane systems of the invention are preferably selected from among polyurethane coatings, polyurethane adhesives, polyurethane sealants, polyurethane elastomers and polyurethane foams. The polyurethane system of the invention is preferably a rigid polyurethane foam, a flexible polyurethane foam, a viscoelastic foam, an HR foam, a semirigid polyurethane foam, a thermoformable polyurethane foam or an integral foam, particularly preferably an HR polyurethane foam. The polyurethane systems of the invention preferably comprise from 0.01 to 5% by weight of tin ricinoleate and/or zinc ricinoleate.

The polyurethane systems of the invention, in particular the polyurethane foams, can be used as refrigerator insulation, insulation board, sandwich element, pipe insulation, spray foam, 1- & 1.5-component pressure-pack foam, imitation wood, modelling foam, packaging foam, mattress, furniture upholstery, automobile seat upholstery, headrest, dashboard, automobile interior trim, automobile interior roof, sound absorption material, steering wheel, shoe sole, carpet backing, filter foam, sealing foam, sealant and adhesive or for producing corresponding products.

In the following examples, the present invention is described by way of example without the invention, whose scope is given by the total description and the claims, being restricted to the embodiments mentioned in the examples.

### EXAMPLES

Foam blocks were produced on a low-pressure foaming machine from Laader Berg model Maxfoam F8. A detailed description of the production of foam blocks may be found in DE 2142450.

The foaming machine was operated at the following parameters:
Polyol output: 250 kg/min,
75 litres barrel volume,
Mixing chamber pressure 4.5 bar,
Stirrer speed: 4500 rpm,
Air loading: 3.0 1/min

The raw materials indicated in Table 1 were used as raw materials for producing the foam blocks.

TABLE 1
Raw materials for producing the foam blocks

| | |
|---|---|
| Polyol 1 | Polyetherol, trifunctional, MW 4800, 25% styrene- |
| | acrylonitrile-filled, PCC Rokita |
| Polyol 2 | Polyetherol, trifunctional, MW 6000, BASF |
| Catalyst 1 | Tegoamin B 75, a mixture of 75% of Tegoamin 33 |
| | (triethylenediamine 33% in dipropylene glycol (DPG)) + 25% |
| | of Tegoamin BDE (bis(2-dimethylaminoethyl) ether 70% |
| | in DPG), Evonik Industries AG |
| Catalyst 2 | Tegoamin DEOA 85 (diethanolamine 85% in water), Evonik |
| | Industries AG |
| Catalyst 3 | Zinc ricinoleate, Evonik Industries AG |
| Catalyst 4 | Tin octoate (29%), Evonik Industries AG |
| Catalyst 5 | Tin ricinoleate, Evonik Industries AG |
| Silicone | Tegostab B 8783 LF 2, Evonik Industries AG |
| stabilizer | |
| Mixture 1 | Polyethylene glycol (20%), water (25%), d-glucitol (45%), |
| | urea (10%) |
| Isocyanate | Tolylene diisocyanate, TDI 80, (80% of 2,4 isomers, 20% |
| | of 2,6 isomers), Bayer MaterialScience AG |

The formulations indicated in Table 2 were used to produce the foam blocks. In this case, the raw materials were pumped via separate lines to the mixing head and stirred/mixed with one another in the respective mixing ratio in the mixing head. Examples C1 to C3 are comparative examples, and Example EM1 is an example according to the invention.

TABLE 2
Formulation for producing the foam blocks
(figures in parts per 100 parts of polyol)

| Example | C1 | C2 | C3 | EM1 |
|---|---|---|---|---|
| Polyol 1 | 70 | 70 | 70 | 70 |
| Polyol 2 | 22 | 22 | 22 | 22 |
| CaCO₃ | 8 | 8 | 8 | 8 |
| Isocyanate index | 101 | 101 | 101 | 101 |
| Isocyanate | 30.18 | 30.18 | 30.18 | 31.65 |
| Water sep. | 2.2 | 2.2 | 2.2 | 1.85 |
| Catalyst 1 | 0.11 | 0.11 | 0.12 | 0.05 |
| Catalyst 2 | 1.2 | 1.2 | 1.2 | 1 |
| Mixture 1 | — | — | — | 1.5 |
| Silicone stabilizer | 0.26 | 0.26 | 0.26 | 0.26 |
| Catalyst 3 | — | — | 0.3 | 0.3 |
| Catalyst 4 | 0.16 | — | 0.12 | 0.12 |
| Catalyst 5 | — | 0.55 | — | — |

A formulation which had Catalyst 3 alone without Mixture 1 resulted in an unstable foam which collapsed.

Foam blocks having an approximate size of about 1.16 m×2.03 m×2.03 m (H×W×D) were obtained.

The density and the hardness distribution (compressive strength, compressive stress) of the foam blocks produced in this way were determined at various places in the blocks. For this purpose, the surface of the foam block was divided into 9 squares. Each foam test specimen composed of the single squares was subjected to a compressive test in accordance with DIN 53577. Here, both the compressive stress in kPa and the sag factor in accordance with ISO 2439 were measured. The sag factor is an index which indicates the relationship between the force required to compress the foam to 65% of the initial thickness and the force required to deform the foam to 25%.

Compressive stresses are expressed as ratios to one another, which is why this parameter does not have a unit. The test specimens were measured by means of an H10KS universal testing machine from Tinius Olsen in the following way:

A 10 cm-thick disc was firstly cut. From this, 10 cm were in turn removed from the bottom zone and 10 cm was removed from each of the two sides of the foam obtained. The remaining foam core was then cut into 5 cm slices. The test specimens having dimensions of 10×10 cm were subsequently produced from these slices.

A measuring punch having dimensions of 10×10 cm was required for the compressive strength measurement and for determining the SAG factor. Here, the punch compresses the test specimen three times before the actual measurement was carried out on the fourth compression. Loading and unloading curves of the foam were recorded. For examples of measurement curves, see: Becker, Braun, Kunststoff-Handbuch, Carl Hanser Verlag, Munich, Volume 7: Polyurethane, p. 494, 1983.

The compressive stress determined at 40% compression corresponds to the compressive strength in kPa. The SAG factor was determined in a similar way, except that here the ratio of the force for compression to 65% to the force required to compress the foam to 25% is formed. vSag is then calculated from the following formula,

$$vSag = \frac{{Sag}^{Max} - {Sag}^{Min}}{{Sag}^{Min}} * 100$$

where the lowest and highest measured values of the SAG factor are employed.

The results of these determinations are shown in Table 3.

TABLE 3
Results of the testing of the density and compressive stress

| | C1 | C2 | C3 | EM1 |
|---|---|---|---|---|
| Density in kg/m³ | | | | |
| Measurement position in the | | | | |
| foam block | | | | |
| Top | 36.4 | 37.4 | 36.6 | 36.5 |
| Middle | 40.1 | 43.0 | 39.4 | 38.5 |
| Bottom | 40.7 | 44.7 | 40.0 | 39.0 |
| Middle of side | 37.8 | 40.5 | 38.0 | 37.9 |
| Average | 38.8 | 41.4 | 38.5 | 38.0 |
| Variation % | 11.1 | 17.6 | 8.8 | 6.6 |
| Compressive strength | | | | |
| (compressive stress) at 40% | | | | |
| compression/deformation in kPa | | | | |
| Measurement position in the | | | | |
| foam block | | | | |
| Top | 3.8 | 3.5 | 3.8 | 4.0 |
| Middle | 4.5 | 4.1 | 4.2 | 4.0 |
| Bottom | 4.2 | 3.8 | 3.7 | 4.0 |
| Middle of side | 4.2 | 4.0 | 4.1 | 4.2 |
| Average | 4.175 | 3.85 | 3.95 | 4.05 |
| Variation % | 16.8 | 15.6 | 10.1 | 4.9 |
| νSag | 33.3 | 68.4 | 21.9 | 4.7 |

As regards to the density distribution, Comparative Example C1 shows that the use of only the catalyst 4 lead to a higher density variation, as does the sole use of catalyst 5 in Example C2 which results in the highest density variations. The combination of catalysts 3 and 4 (Comparative Example C3) gave a more homogeneous distribution of the density over the total foam block. The variations in the hardness also follow this trend.

The best results were obtained for the combination of catalysts 3 and 4 with the mixture according to the invention (Mixture 1). Here, a completely homogeneous hardness distribution was even obtained. In addition, the use of this catalyst combination with the Mixture 1 enabled the amount of Catalysts 1 and 2 to be decreased significantly.

While the present invention has been particularly shown and described with reference to the preferred embodiments, it will be readily appreciated by those of ordinary skill in the art that various changes and modifications may be made without departing from the spirit and scope of the invention. It is intended that the present invention be understood to cover the disclosed embodiments, those alternatives which have been discussed and all equivalents thereto.

What is claimed is:

1. A formulation comprising tin ricinoleate or zinc ricinoleate or a combination of tin ricinoleate and zinc ricinoleate, a mixture of urea, sugar alcohol and polyethylene glycol, one or more organic isocyanates having two or more isocyanate functions, one or more polyols having two or more groups which are reactive towards isocyanate, and water.

2. The formulation according to claim 1, wherein the weight ratio of urea to sugar alcohol is from 1:1 to 1:10.

3. The formulation according to claim 1, wherein the weight ratio of urea to polyethylene glycol is from 1:0.5 to 1:4.

4. The formulation according to claim 1, further comprising tin carboxylate.

5. The formulation according to claim 4, wherein the mass ratio of the sum of the masses of tin ricinoleate and zinc ricinoleate to the sum of the mass of said tin carboxylate is from 10:1 to 1:1.

6. The formulation according to claim 1, further comprising one or more amines, one or more silicone stabilizers and/or one or more emulsifiers as further additives.

7. The formulation according to claim 1, wherein the sugar alcohol is sorbitol.

8. The formulation according to claim 1, wherein the polyethylene glycol has an average molecular weight MW of from 250 to 1000 g/mol.

9. A process for the production of a polyurethane system, comprising mixing tin ricinoleate or zinc ricinoleate or a combination of tin ricinoleate and zinc ricinoleate, urea, sugar alcohol, polyethylene glycol, one or more organic isocyanates having two or more isocyanate functions, one or more polyols having two or more groups which are reactive towards isocyanate, and water, and reacting said mixture to form urethane bonds.

10. The process according to claim 9, wherein said reacting provides polyurethane coatings, polyurethane adhesives, polyurethane sealants, polyurethane elastomers or polyurethane foams.

11. The process according to claim 9, wherein said mixing further comprises tin carboxylate.

12. The process according to claim 9, wherein said sugar is sorbitol.

13. The process according to claim 9, wherein said at least one of tin rincinoleate and zinc ricinoleate is present in an amount from 0.01 to 5% by weight.

14. The process according to claim 9, wherein said reacting provides a rigid polyurethane foam, a flexible polyurethane foam, a viscoelastic foam, an HR foam, a semirigid polyurethane foam, a thermoformable polyurethane foam or an integral foam.

15. A polyurethane product comprising polyurethane and tin ricinoleate or zinc ricinoleate or a combination of tin ricinoleate or zinc ricinoleate, and a mixture of urea, sugar alcohol and polyethylene glycol.
